(19) United States
(12) Patent Application Publication
(10) Pub. No.: US 2026/0084737 A1
(43) Pub. Date: Mar. 26, 2026

(54) BUNDLE-SHAPED FOLDED SUPPORT FRAME AND FOLDING CART

(71) Applicant: Wuyi Migo Leisure Products Co., Ltd., Jinhua (CN)

(72) Inventor: Peiwu WU, Wuhu (CN)

(73) Assignee: Wuyi Migo Leisure Products Co., Ltd., Jinhua (CN)

(21) Appl. No.: 18/979,364

(22) Filed: Dec. 12, 2024

(30) Foreign Application Priority Data
Sep. 26, 2024 (CN) 2024223573204

(51) Int. Cl. B62B 3/02; B62B 5/06

(52) U.S. Cl. CPC B62B 3/02; B62B 5/067; B62B 2205/06; B62B 2205/30

(57) ABSTRACT

The present invention discloses a bundle-shaped folded support frame and a folding cart. The support frame includes a cart frame body, a wheel body assembly, and a pull handle assembly. The cart frame body includes a front shear fork group, a rear shear fork group, a left shear fork group and a right shear fork group, and further includes a first support stand column, a second support stand column, a third support stand column, and an underframe structure. The underframe structure includes a first underframe assembly and a second underframe assembly. The first underframe assembly and the second underframe assembly are respectively provided with a first mounting member, a second mounting member, a third mounting member, and a first connecting member, a first bottom rod, a second bottom rod and a third bottom rod.

### CROSS-REFERENCE TO RELATED APPLICATIONS

The application claims priority to Chinese patent application No. 2024223573204, filed on Sep. 26, 2024, the entire contents of which are incorporated herein by reference.

### TECHNICAL FIELD

The present invention relates to the field of carts, and in particular, to a bundle-shaped folded support frame and a folding cart.

### BACKGROUND

With the improvement of people's quality of life, the number of travel times is increased, and heavy luggage needs to be solved by a cart. Ordinary carts are inconvenient to carry, and therefore, there is an increasing demand for foldable carts.

In view of the above problems, the invention patent publication No. CN218112682U discloses a quick-release folding cart with assembly and gathering functions which is folded and drawn close through two side wall assemblies which are in bilateral symmetry. In the present invention, four stand column pipes are mounted at front ends and the rear ends of the two side wall assemblies respectively, lower ends of outer walls of the stand column pipes are connected to underframe fixed seats, and foldable cross assemblies are arranged between the two stand column pipes on the front side and between the two stand column pipes on the rear side, so that the whole cart can be folded and gathered. However, a single cross assembly at the bottom serves as a bottom support, and when the whole cart sleeve is sleeved with a cloth pocket, since the bottom support is the single cross assembly, the overall structural stability of the folding cart support frame is poor, causing that the whole cart is prone to deformation when being loaded with a heavy object.

### SUMMARY

In view of the shortcomings in the prior art, the present invention provides a bundle-shaped folded support frame and a folding cart. The overall structure of the support frame is more stable and firmer, the loading capacity is higher, and the support frame is not prone to deformation when being loaded with heavy objects.

The present invention provides a bundle-shaped folded support frame and a folding cart, including a cart frame body, a wheel body assembly used for driving the cart frame body to move, and a pull handle assembly used for pushing and pulling the cart frame body, where the cart frame body includes a front shear fork group, a rear shear fork group, a left shear fork group and a right shear fork group, and further includes a first support stand column rotatably connected to end portions of the two adjacent shear fork groups, a second support stand column rotatably connected to the left shear fork group, a third support stand column rotatably connected to the right shear fork group, and an underframe structure connected among lower portions of each first support stand column, second support stand column and third support stand column; the second support stand column and the third support stand column are arranged opposite to each other, the underframe structure includes a first underframe assembly disposed between the lower portion of the first support stand column at two ends of the front shear fork group and the second support stand column and the third support stand column arranged opposite to each other, and a second underframe assembly disposed between the lower portion of the first support stand column at two ends of the rear shear fork group and the second support stand column and the third support stand column arranged opposite to each other; and the first underframe assembly and the second underframe assembly are respectively provided with a first mounting member connected to the lower portion of each first support stand column, a second mounting member connected to the lower portion of the second support stand column, a third mounting member connected to the lower portion of the third support stand column, and a first connecting member, a first bottom rod of which two ends are rotatably connected to a lower side of the first connecting member and an upper side of the first mounting member respectively, a second bottom rod of which two ends are rotatably connected to the lower side of the first connecting member and an upper side of the second mounting member respectively, and a third bottom rod of which two ends are rotatably connected to the lower side of the first connecting member and an upper side of the third mounting member respectively, and when the cart frame body is driven to fold, the front, rear, left and right shear fork groups deform to drive the first support stand columns, the second support stand columns and the third support stand columns to gather with each other, and the first bottom rod, the second bottom rod and the third bottom rod are gathered to drive the first connecting member to move upwards.

Preferably, the first connecting member is provided with four first connecting portions used for connecting the two first bottom rods, the second bottom rod, and the third bottom rod respectively, each first connecting portion includes two first connecting side plates arranged opposite to each other in a longitudinal direction and a first connecting top plate connected between upper portions of the two first connecting side plates, the two first connecting side plates and the first connecting top plate surround to form a first connecting groove used for arranging an end portion of the bottom rod, and the first connecting side plates are rotatably connected to the bottom rod through a first connecting shaft.

Preferably, the first connecting portion further includes a first limiting member fixedly connected to an inner side of the first connecting groove, the first limiting member includes first limiting plates respectively arranged at inner sides of the two first connecting side plates and a first limiting portion connected between upper portions of the two first limiting plates, the first limiting portion is arranged at one end of the first connecting side plate close to the support stand column, the first connecting shaft is arranged at one end of the first connecting side plate away from the support stand column, the first limiting portion is provided with a first limiting surface arranged at the bottom and a second limiting surface close to one side of the first connecting shaft, an outer side of the bottom rod is provided with a first abutting surface and second abutting surfaces arranged at intervals on one side of the first abutting surface away from the support stand column, when the support frame is driven to be unfolded, the first abutting surface can abut against the first limiting surface for limiting, and when the cart frame body is driven to be folded, the second abutting surface can abut against the second limiting surface for limiting.

Preferably, the first connecting member includes a first connecting strip and a second connecting strip arranged perpendicular to each other in a crossed manner, a lower opening portion is arranged in the middle of the first connecting strip, an upper opening portion is arranged in the middle of the second connecting strip, the lower opening connecting portion is matched with the upper opening connecting portion in a buckled manner, after matching, a top surface of the first connecting strip and a top surface of the second connecting strip are located on the same plane and a bearing support surface used for abutting against the bottom of a cloth cover structure is formed, and the first connecting portions are formed at two ends of the first connecting strip and the second connecting strip respectively.

Preferably, the first mounting member includes a first mounting base portion that is sleeved with the lower portion of the first support stand column and is relatively fixed, and a first mounting portion connected to one side of the first mounting base portion, the first mounting portion includes two first mounting side plates arranged opposite to each other in a longitudinal direction and a first mounting bottom plate connected between lower portions of the two first mounting side plates, the two first mounting side plates and the first mounting bottom plate surround to form a first mounting groove used for arranging an end portion of the first bottom rod, and the first mounting side plates are rotatably connected to the first bottom rod through a first mounting shaft; the first mounting portion further includes a first stopping member fixedly connected in the first mounting groove, the first stopping member includes first stopping plates respectively arranged at inner sides of the two first mounting side plates and a first stopping portion connected between lower portions of the two first stopping plates, the first stopping portion is arranged at one end of the first mounting side plate close to the first connecting member, the first mounting shaft is arranged at one end of the first mounting side plate away from the first connecting member, the first stopping portion is provided with a first stopping surface arranged at the top and a second stopping surface close to one side of the first mounting shaft, an outer side of the first bottom rod is provided with a third abutting surface and fourth abutting surfaces arranged at intervals on one side of the third abutting surface away from the first connecting member, when the support frame is driven to be unfolded, the third abutting surface can abut against the first stopping surface for limiting, and when the cart frame body is driven to be folded, the fourth abutting surface can abut against the second stopping surface for limiting, the first stopping portion and the two first stopping plates surround to form a groove matched with the first bottom rods arranged correspondingly, and the first limiting portion and the two limiting plates surround to form a groove matched with the bottom rods arranged correspondingly; or

the first mounting member includes a first mounting base portion that is sleeved with the lower portion of the first support stand column and is relatively fixed, a first mounting portion connected to one side of the first mounting base portion, and a second mounting portion connected to the other side of the first mounting base portion, the first mounting portion is rotatably connected to the first bottom rod, the second mounting portion includes two second mounting side plates arranged opposite to each other in a longitudinal direction and a second mounting groove formed by the two second mounting side plates in a surrounding manner, the pull handle assembly includes a pull handle rod, two connecting rods respectively arranged at two sides of the pull handle rod, a first connecting structure connected between a lower portion of the pull handle rod and upper ends of the two connecting rods, and a second connecting structure respectively connected between lower ends of the two connecting rods and the two first mounting portions, two ends of each connecting rod are rotatably connected to the first connecting structure and the second connecting structure through a rotating shaft arranged transversely, a lower portion of the second connecting structure is located in the second mounting groove and is rotatably connected to the second mounting side plates through a second mounting shaft, the rotating shaft is arranged along a length direction of the cart frame body, and the second mounting shaft is arranged along a width direction of the cart frame body.

Preferably, the second mounting member and the third mounting member respectively includes a second mounting base portion that is sleeved with the lower portions of the second support stand column and the third support stand column and is relatively fixed, and a third mounting portion connected to a side portion of the second mounting base portion, the third mounting portion includes two third mounting side plates arranged opposite to each other in a longitudinal direction and a third mounting bottom plate connected between lower portions of the two third mounting side plates, the two third mounting side plates and third mounting bottom plate surround to form a third mounting groove used for arranging end portions of the second bottom rod and the third bottom rod, and the third mounting side plates are rotatably connected to the second bottom rod and the third bottom rod through a third mounting shaft; and the third mounting portion further includes a second stopping member fixedly connected in the third mounting groove, the second stopping member includes second stopping plates respectively arranged at inner sides of the two third mounting side plates and a second stopping portion connected between lower portions of the two second stopping plates, the second stopping portion is arranged at one end of the third mounting side plate close to the first connecting member, the third mounting shaft is arranged at one end of the third mounting side plate away from the first connecting member, the second stopping portion is provided with a fifth limiting surface arranged at the top and a sixth limiting surface close to one side of the first mounting shaft, outer sides of the second bottom rod and the third bottom rod are provided with a fifth abutting surface and sixth abutting surfaces arranged at intervals on one side of the fifth abutting surface away from the first connecting member, when the support frame is driven to be unfolded, the fifth abutting surface can abut against the fifth limiting surface for limiting, when the cart frame body is driven to be folded, the sixth abutting surface can abut against the sixth limiting surface for limiting, and the second stopping portion and the two second stopping plates surround to form a groove matched with the second bottom rods arranged correspondingly and the third bottom rods arranged correspondingly.

Preferably, the second mounting member of the first underframe assembly is integrally formed with the second mounting member of the second underframe assembly to form a second mounting structure, and the second mounting base portion of the second mounting member of the first underframe assembly and the second mounting base portion of the second mounting member of the second underframe assembly are of a same structure; and the third mounting member of the first underframe assembly is integrally formed with the third mounting member of the second underframe assembly to form a third mounting structure, and the second mounting base portion of the third mounting member of the first underframe assembly and the second mounting base portion of the third mounting member of the second underframe assembly are of a same structure.

Preferably, the underframe structure further includes a third underframe assembly arranged between the first underframe assembly and the second underframe assembly, the third underframe assembly includes a fourth bottom rod, a fifth bottom rod, and a second connecting member, the second connecting member is provided with two second connecting portions arranged in a same straight line direction, each second connecting portion includes two second connecting side plates arranged opposite to each other in a longitudinal direction and a second connecting top plate connected between upper portions of the two second connecting side plates, the two second connecting side plates and the second connecting top plate surround to form a second connecting groove used for arranging end portions of the fourth bottom rod and the fifth bottom rod, and the second connecting side plates are rotatably connected to the fourth bottom rod and the fifth bottom rod through a second connecting shaft; the second mounting structure and the third mounting structure each include a fourth mounting portion connected to a side portion of the second mounting base portion and/or a side portion of the third mounting portion, the fourth mounting portion is arranged between the two third mounting portions, and the fourth mounting portion on the second mounting structure and the fourth mounting portion on the third mounting structure are arranged in a same straight line direction, the fourth mounting portion includes two fourth mounting side plates arranged opposite to each other in a longitudinal direction and a fourth mounting bottom plate connected between lower portions of the two fourth mounting side plates, the two fourth mounting side plates and the fourth mounting bottom plate surround to form a fourth mounting groove used for arranging other end portions of the fourth bottom rod and the fifth bottom rod, and the fourth mounting side plates are rotatably connected to the fourth bottom rod and the fifth bottom rod through a fourth mounting shaft; and when the cart frame body is driven to be folded, the fourth bottom rod and the fifth bottom rod are gathered with each other to drive the second connecting member to move upwards.

Preferably, the first support stand column includes a first support lower column and a first support upper column that is telescopically sleeved in the first support lower column, the first support lower column and the first support upper column are telescopically positioned through a first positioning assembly, a third connecting structure is fixedly connected to an upper portion of the first support lower column, and a fourth connecting structure is slidably connected to a lower portion of the first support lower column, upper portions of two ends of the front, rear, left, and right shear fork groups are rotatably connected to the third connecting structures arranged correspondingly, respectively, and lower portions of two ends of the front, rear, left, and right shear fork groups are rotatably connected to the fourth connecting structures arranged correspondingly, respectively, the first positioning assembly includes a first elastic member connected to the first support upper column, a first positioning channel formed in the first support lower column and used for the first elastic member to partially protrude out of the first support lower column, and a pressing member integrally disposed with an outer side of the third connecting structure or detachably connected to an outer side of the third connecting structure and used for pushing the first elastic member to contract into the first support lower column; and/or,
the pull handle assembly includes a pull handle lower rod and a pull handle upper rod that is telescopically sleeved in the pull handle lower rod, the pull handle lower rod and the pull handle upper rod are telescopically positioned through a second positioning assembly, a handle member is connected to an upper end of the pull handle upper rod, and the second positioning assembly includes a second elastic member connected to the pull handle upper rod, and a second positioning channel formed in the pull handle lower rod and used for the second elastic member to partially protrude out of the pull handle lower rod.

The present invention provides a folding cart, including the foregoing support frame and a cloth cover structure mounted in the cart frame body, a third connecting structure is fixedly connected to an upper portion of the first support stand column, and a fourth connecting structure is slidably connected to a lower portion of the first support stand column, upper portions of two ends of the front, rear, left, and right shear fork groups are rotatably connected to the third connecting structures arranged correspondingly, respectively, and lower portions of two ends of the front, rear, left, and right shear fork groups are rotatably connected to the fourth connecting structures arranged correspondingly, respectively; and a first mounting buckle arranged corresponding to the third connecting structure is arranged on the cloth cover structure, a first quick-release buckle detachably connected to the first mounting buckle is arranged on an inner side of the third connecting structure, and a second quick-release buckle used for connecting an accessory is arranged on an outer side of the third connecting structure.

According to the support frame of the present invention, the cart frame body forms an integral folding structure with the first, second, and third support stand columns and the underframe structure through the front, rear, left and right shear fork groups. The underframe structure includes the first underframe assembly and the second underframe assembly. The first underframe assembly is disposed between the lower portion of the first support stand column at two ends of the front shear fork group and the second support stand column and the third support stand column arranged opposite to each other, and the second underframe assembly is disposed between the lower portion of the first support stand column at two ends of the rear shear fork group and the second support stand column and the third support stand column arranged opposite to each other. Compared with an underframe structure of a single cross assembly in the prior art, the overall structure of the support frame is more stable and firmer, the loading capacity is higher, and the support frame is not prone to deformation when being loaded with heavy objects. In addition, when the cart frame body is driven to be folded, the front, rear, left and right shear fork groups deform to drive the first support stand columns, the second support stand columns and the third support stand columns to gather with each other, and the first bottom rod, the second bottom rod and the third bottom rod on the first underframe assembly and the second underframe assembly are gathered with each other through rotatable connection between the mounting members and the lower portions of the support stand columns, and the first connecting member is driven to move upwards. Compared with an underframe structure of a single cross assembly in the prior art, the length of a single bottom rod is greatly shortened, so that the space height occupied when the whole cart is idle is significantly reduced, and it is more convenient for storage and carrying during travel.

The additional advantages of the present invention will be partially presented in the following description, some of which will become apparent from the following description, or learned through practice of the present invention.

### BRIEF DESCRIPTION OF THE DRAWINGS

The drawings described herein are intended for a further understanding of the present invention and constitute a part of this application. Example embodiments of the present invention and descriptions thereof are intended to explain the present invention, and do not constitute any inappropriate limitation on the present invention. In the accompanying drawings:

FIG. 1 is a schematic structural diagram of a support frame according to an embodiment of the present invention;

FIG. 2 is a schematic diagram of a bottom structure of a support frame according to an embodiment of the present invention;

FIG. 3 is an enlarged view of a position A in FIG. 2;

FIG. 4 is a schematic structural diagram of a first connecting member according to an embodiment of the present invention;

FIG. 5 is a schematic structural diagram of a first connecting strip according to an embodiment of the present invention;

FIG. 6 is a schematic structural diagram of a second connecting strip according to an embodiment of the present invention;

FIG. 7 is a schematic structural diagram of a first mounting member according to an embodiment of the present invention;

FIG. 8 is a use state diagram of a first mounting member according to an embodiment of the present invention;

FIG. 9 is a schematic structural diagram of a third mounting portion according to an embodiment of the present invention;

FIG. 10 is a use state diagram of a third mounting portion according to an embodiment of the present invention;

FIG. 11 is a schematic structural diagram of a third underframe assembly according to an embodiment of the present invention;

FIG. 12 is a schematic structural diagram of a second connecting member according to an embodiment of the present invention;

FIG. 13 is a schematic structural diagram of a fourth mounting portion according to an embodiment of the present invention;

FIG. 14 is a schematic structural diagram of a support stand column according to an embodiment of the present invention;

FIG. 15 is a schematic structural diagram of a pull handle assembly according to an embodiment of the present invention;

FIG. 16 is a schematic structural diagram of a folding cart according to another embodiment of the present invention;

FIG. 17 is a schematic structural diagram of a use state of a folding cart according to another embodiment of the present invention;

FIG. 18 is a schematic structural diagram of a quick-release structure of a folding cart according to another embodiment of the present invention; and

FIG. 19 is a folding state diagram of a folding cart according to another embodiment of the present invention.

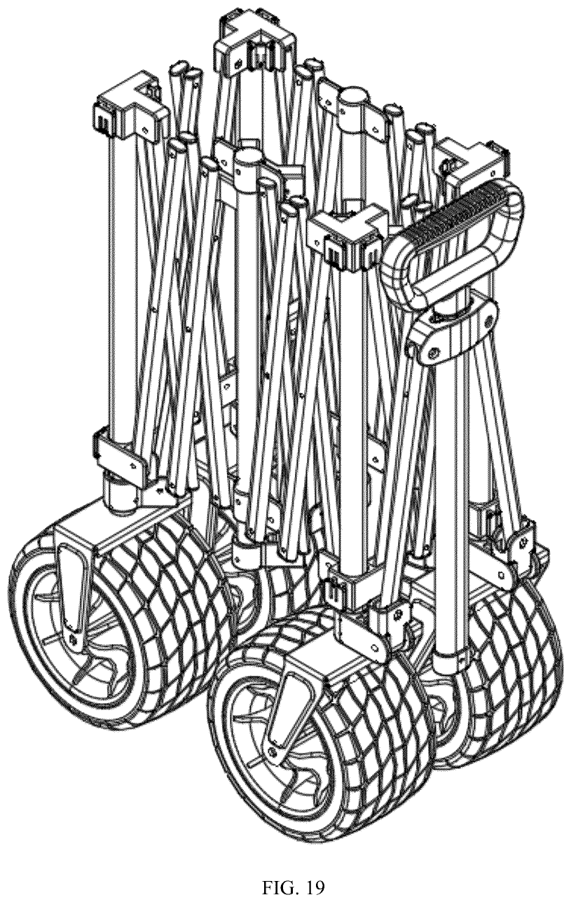

### DETAILED DESCRIPTION OF THE EMBODIMENTS

To make the purpose, technical solutions, and advantages of the embodiments of the present invention clearer, the following clearly and completely describes the technical solutions of the embodiments of the present invention with reference to the accompanying drawings in the embodiments of the present invention. Apparently, the embodiments described are a part rather than all of the embodiments of the present invention. All other embodiments obtained by a person of ordinary skill in the art based on the described embodiments of the present invention without creative efforts shall fall within the protection scope of the present invention.

In the description of the present invention, it should be understood that the orientations or positional relationships indicated by the terms “upper”, “lower”, “front”, “rear”, “left”, “right”, “top”, “bottom”, “inner”, “outer”, and the like are in accordance with those shown in the accompanying drawings, and are intended only for the convenience of describing the present invention and simplifying the description rather than for indicating or implying that the referred devices or elements must be provided with a particular orientation or constructed or operated in a particular orientation; and therefore, these terms should not be construed as limiting the present invention.

In the present invention, unless otherwise explicitly specified and limited, the terms “mounted”, “attached”, “connected”, “fixed”, etc. should be understood in a broad sense, e.g., it may be a fixed connection, a detachable connection or an integral connection; it may be a mechanical connection or an electrical connection; it may be a direct attachment, or an indirect attachment through an intermediate medium; and it may be a communication within two elements. For those of ordinary skill in the art, the specific meanings of the above terms in the present invention can be understood on a case-by-case basis.

In the present invention, unless otherwise expressly specified and defined, a first feature being “above” or “below” a second feature may include not only direct contact between the first and second features but also indirect contact between the first and second features via another feature between them. Furthermore, a first feature being “above” a second feature includes the first feature being directly above and diagonally above the second feature, or simply means that the first feature is higher in level than the second feature. Furthermore, a first feature being “below” a second feature includes the first feature being directly below and diagonally below the second feature, or simply means that the first feature is lower in level than the second feature.

Unless otherwise defined, the technical or scientific terms used herein shall have the common meanings as understood by those skilled in the art to which the present invention belongs. The terms “first”, “second”, and the like used in the description and claims of the present invention are not intended to indicate any sequence, amount or importance, but distinguish different components. Also, the terms such as “a”, “an”, and the like are not intended to limit the amount, but indicate the existence of at least one.

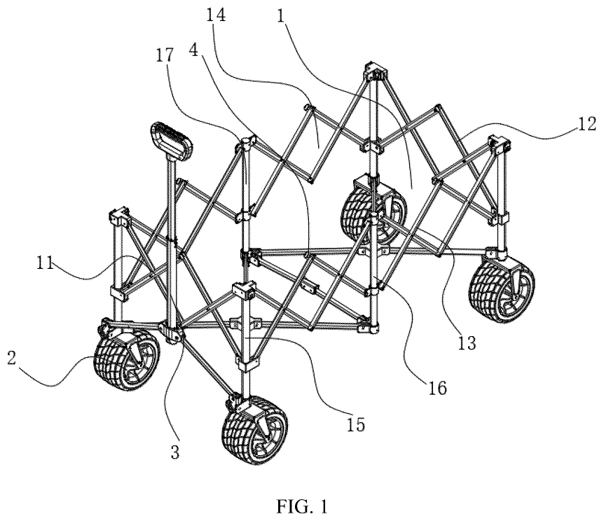

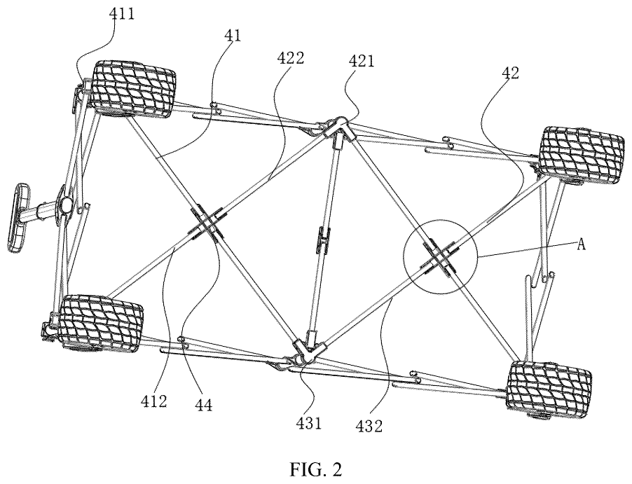

As shown in FIG. 1 and FIG. 2, as an embodiment of the present invention, a bundle-shaped folded support frame is provided, including a cart frame body 1, a wheel body assembly 2 used for driving the cart frame body to move, and a pull handle assembly 3 used for pushing and pulling the cart frame body, where the cart frame body includes a front shear fork group 11, a rear shear fork group 12, a left shear fork group 13 and a right shear fork group 14, and further includes a first support stand column 15 rotatably connected to end portions of the two adjacent shear fork groups, a second support stand column 16 rotatably connected to the left shear fork group, a third support stand column 17 rotatably connected to the right shear fork group, and an underframe structure 4 connected among lower portions of each first support stand column 15, second support stand column 16 and third support stand column 17. Through deformation among the shear fork groups, the whole cart can be folded, thereby reducing the floor space when the cart is not in use, and facilitating carrying and storage. The second support stand column 16 and the third support stand column 17 are arranged opposite to each other, the underframe structure 4 includes a first underframe assembly 41 disposed between the lower portion of the first support stand column 15 at two ends of the front shear fork group 11 and the second support stand column 16 and the third support stand column 17 arranged opposite to each other, and a second underframe assembly 42 disposed between the lower portion of the first support stand column 15 at two ends of the rear shear fork group 12 and the second support stand column 16 and the third support stand column 17 arranged opposite to each other. The first underframe assembly 41 and the second underframe assembly 42 are respectively provided with a first mounting member 411 connected to the lower portion of each first support stand column 15, a second mounting member 421 connected to the lower portion of the second support stand column 16, a third mounting member 431 connected to the lower portion of the third support stand column 17, and a first connecting member 44, a first bottom rod 412 of which two ends are rotatably connected to a lower side of the first connecting member 44 and an upper side of the first mounting member 411 respectively, a second bottom rod 422 of which two ends are rotatably connected to the lower side of the first connecting member 44 and an upper side of the second mounting member 421 respectively, and a third bottom rod 432 of which two ends are rotatably connected to the lower side of the first connecting member 44 and an upper side of the third mounting member 431 respectively, and when the cart frame body is driven to fold, the front, rear, left and right shear fork groups deform to drive the first support stand columns 15, the second support stand columns 16 and the third support stand columns 17 to gather with each other, and the first bottom rod 412, the second bottom rod 422 and the third bottom rod 432 are gathered to drive the first connecting member 44 to move upwards. According to the support frame of this embodiment, the cart frame body 1 forms an integral folding structure with the first, second, and third support stand columns and the underframe structure 4 through the front, rear, left and right shear fork groups. The underframe structure 4 includes the first underframe assembly 41 and the second underframe assembly 42.

The first underframe assembly 41 is disposed between the lower portion of the first support stand column 15 at two ends of the front shear fork group 11 and the second support stand column 16 and the third support stand column 17 arranged opposite to each other, and the second underframe assembly 42 is disposed between the lower portion of the first support stand column 15 at two ends of the rear shear fork group 12 and the second support stand column 16 and the third support stand column 17 arranged opposite to each other. Compared with an underframe structure 4 of a single cross assembly in the prior art, the overall structure of the support frame is more stable and firmer, the loading capacity is higher, and the support frame is not prone to deformation when being loaded with a heavy object. In addition, when the cart frame body is driven to be folded, the front, rear, left and right shear fork groups deform to drive the first support stand columns 15, the second support stand columns 16 and the third support stand columns 17 to gather with each other, and the first bottom rod 412, the second bottom rod 422 and the third bottom rod 432 on the first underframe assembly 41 and the second underframe assembly 42 are gathered with each other through rotatable connection between the mounting members and the lower portions of the support stand columns, and the first connecting member 44 is driven to move upwards. Compared with an underframe structure of a single cross assembly in the prior art, the length of a single bottom rod is greatly shortened, so that the space height occupied when the whole cart is idle is significantly reduced, and it is more convenient for storage and carrying during travel.

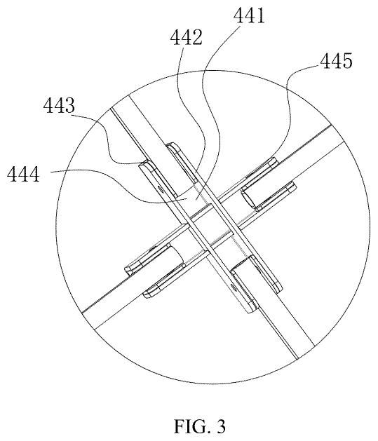

In another embodiment, as shown in FIG. 3, the first connecting member 44 is provided with four first connecting portions 441 used for connecting the two first bottom rods 412, the second bottom rod 422, and the third bottom rod 432 respectively, each first connecting portion 441 includes two first connecting side plates 442 arranged opposite to each other in a longitudinal direction and a first connecting top plate 443 connected between upper portions of the two first connecting side plates 442, and the two first connecting side plates 442 and the first connecting top plate 443 surround to form a first connecting groove 444 used for arranging an end portion of the bottom rod. One end of the bottom rod is connected into the first connecting groove 444, so that an upper end of the bottom rod and an upper end of the first connecting member form a complete bearing surface, the area of a support surface is increased, and the loading capacity is improved. In addition, the first connecting side plates 442 are rotatably connected to the bottom rod through a first connecting shaft 445, so that deformation of the bottom plate is more convenient when the whole cart is folded.

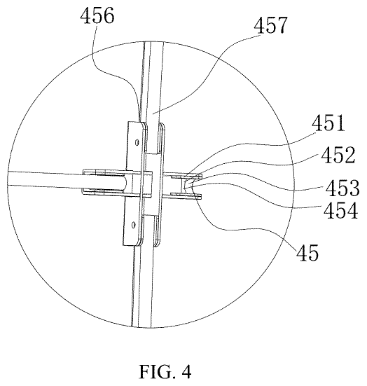

As shown in FIG. 3 and FIG. 4, the first connecting portion 441 further includes a first limiting member 45 fixedly connected to an inner side of the first connecting groove 444, the first limiting member 45 includes first limiting plates 451 respectively arranged at inner sides of the two first connecting side plates 442 and a first limiting portion 452 connected between upper portions of the two first limiting plates 451, the first limiting portion 452 is arranged at one end of the first connecting side plate 442 close to the support stand column, the first connecting shaft 445 is arranged at one end of the first connecting side plate 442 away from the support stand column, the first limiting portion 452 is provided with a first limiting surface 453 arranged at the bottom and a second limiting surface 454 close to one side of the first connecting shaft 445, an outer side of the bottom rod is provided with a first abutting surface 456 and second abutting surfaces 457 arranged at intervals on one side of the first abutting surface 456 away from the support stand column, the first connecting shaft 445 is rotatably connected among the bottom rod, the first limiting plate 451 and the first connecting side plate 442, so that the first connecting shaft can be operated more smoothly and easily when the state changes. When the support frame is driven to be unfolded, the first abutting surface 456 can abut against the first limiting surface 453 for limiting, so that the bottom rod and the first connecting member are limited in parallel to form a flat support surface, and when the cart frame body is driven to be folded, the second abutting surface 457 can abut against the second limiting surface 454 for limiting, so that a gap between the bottom rods is reduced, and the occupied space for folding of the whole cart is smaller.

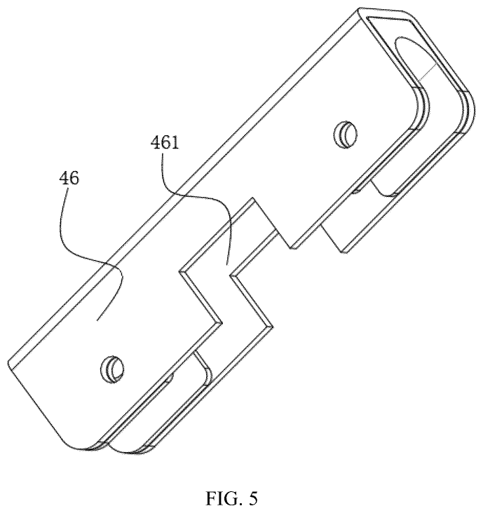

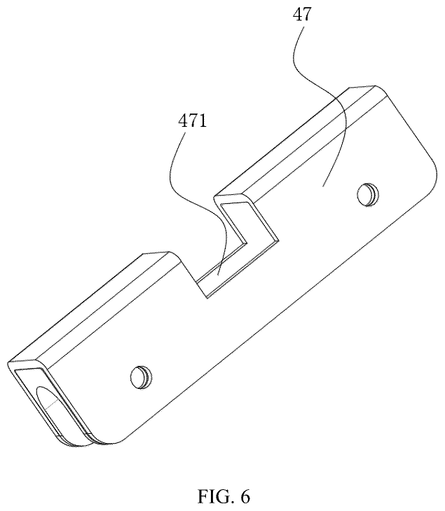

As shown in FIG. 5 and FIG. 6, the first connecting member 44 includes a first connecting strip 46 and a second connecting strip 47 arranged perpendicular to each other in a crossed manner, a lower opening portion 461 is arranged in the middle of the first connecting strip 46, an upper opening portion 471 is arranged in the middle of the second connecting strip 47, the lower opening connecting portion 461 is matched with the upper opening connecting portion 471 in a buckled manner, so that the first connecting strip and the second connecting strip are more compact in structure and are not prone to displacement that may cause a position change in the bottom rod, and after matching, a top surface of the first connecting strip 46 and a top surface of the second connecting strip 47 are located on the same plane and a bearing support surface used for abutting against the bottom of a cloth cover structure is formed. The first connecting portions 441 are formed at two ends of the first connecting strip and the second connecting strip respectively. The top surface of the first connecting strip and the top surface of the second connecting strip are located on the same plane, so that an object carrying surface is flatter, and the loading is more stable.

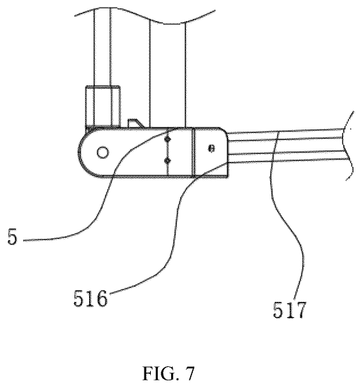

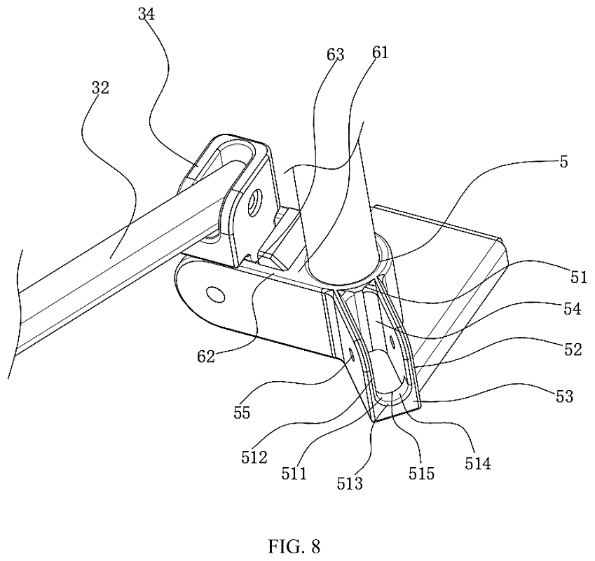

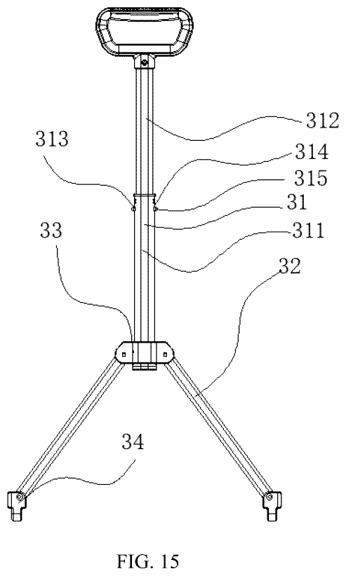

As shown in FIG. 7, FIG. 8 and FIG. 15, the first mounting member 411 includes a first mounting base portion 5 that is sleeved with the lower portion of the first support stand column 15 and is relatively fixed, and a first mounting portion 51 connected to one side of the first mounting base portion 5, the first mounting portion 51 includes two first mounting side plates 52 arranged opposite to each other in a longitudinal direction and a first mounting bottom plate 53 connected between lower portions of the two first mounting side plates 52, the two first mounting side plates 52 and the first mounting bottom plate 53 surround to form a first mounting groove 54 used for arranging an end portion of the first bottom rod 412, and the first mounting side plates 52 are rotatably connected to the first bottom rod 412 through a first mounting shaft 55; the first mounting portion 51 further includes a first stopping member 511 fixedly connected in the first mounting groove 54, the first stopping member 511 includes first stopping plates 512 respectively arranged at inner sides of the two first mounting side plates 52 and a first stopping portion 513 connected between lower portions of the two first stopping plates 512, the first stopping portion 513 is arranged at one end of the first mounting side plate 52 close to the first connecting member 44, the first mounting shaft 55 is arranged at one end of the first mounting side plate 52 away from the first connecting member 44, the first stopping portion 513 is provided with a first stopping surface 514 arranged at the top and a second stopping surface 515 close to one side of the first mounting shaft 55, an outer side of the first bottom rod 412 is provided with a third abutting surface 516 and fourth abutting surfaces 517 arranged at intervals on one side of the third abutting surface 516 away from the first connecting member 44, when the support frame is driven to be unfolded, the third abutting surface 516 can abut against the first stopping surface 514 for limiting, so that the two ends of the bottom rod can be kept parallel to each other, and the loading stability is improved, and when the cart frame body is driven to be folded, the fourth abutting surface 517 can abut against the second stopping surface 515 for limiting, the first stopping portion 513 and the two first stopping plates 512 surround to form a groove matched with the first bottom rods 412 arranged correspondingly, and the first limiting portion 452 and the two limiting plates surround to form a groove matched with the bottom rods arranged correspondingly, so that the positions of the bottom rods do not deviate, folding and unfolding are easier, the bottom rods are more fitted together after being folded, and the size after being folded is reduced, or
the first mounting member 411 includes a first mounting base portion 5 that is sleeved with the lower portion of the first support stand column 15 and is relatively fixed, a first mounting portion 51 connected to one side of the first mounting base portion 5, and a second mounting portion 61 connected to the other side of the first mounting base portion 5, the first mounting portion 51 is rotatably connected to the first bottom rod 412, the second mounting portion 61 includes two second mounting side plates 62 arranged opposite to each other in a longitudinal direction and a second mounting groove 63 formed by the two second mounting side plates 62 in a surrounding manner, the pull handle assembly 3 includes a pull handle rod 31, two connecting rods 32 respectively arranged at two sides of the pull handle rod 31, a first connecting structure 33 connected between a lower portion of the pull handle rod 31 and upper ends of the two connecting rods 32, and a second connecting structure 34 respectively connected between lower ends of the two connecting rods 32 and the two first mounting portions 51, two ends of each connecting rod 32 are rotatably connected to the first connecting structure 33 and the second connecting structure 34 through a rotating shaft arranged transversely, a lower portion of the second connecting structure 34 is located in the second mounting groove 63 and is rotatably connected to the second mounting side plates 62 through a second mounting shaft 64, the rotating shaft is arranged along a length direction of the cart frame body, and the second mounting shaft 64 is arranged along a width direction of the cart frame body, so that the pull handle can rotate relative to a front main frame base to adjust a pulling force angle, facilitating steering when pushing, and being more flexible.

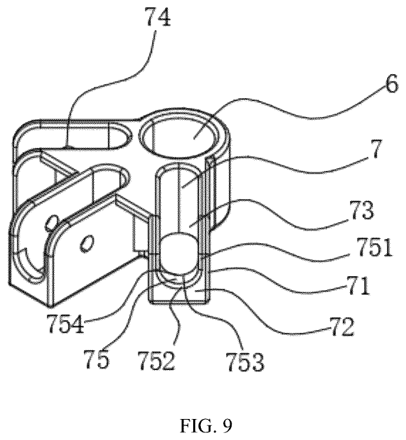

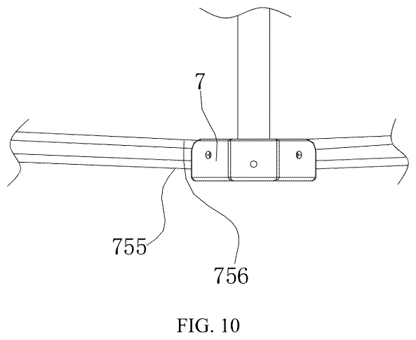

As shown in FIG. 8 to FIG. 10, the second mounting member and the third mounting member respectively includes a second mounting base portion 6 that is sleeved with the lower portions of the second support stand column and the third support stand column and is relatively fixed, and a third mounting portion 7 connected to a side portion of the second mounting base portion 6, the third mounting portion 7 includes two third mounting side plates 71 arranged opposite to each other in a longitudinal direction and a third mounting bottom plate 72 connected between lower portions of the two third mounting side plates 71, the two third mounting side plates 71 and third mounting bottom plate 72 surround to form a third mounting groove 73 used for arranging end portions of the second bottom rod and the third bottom rod, and the third mounting side plates 71 are rotatably connected to the second bottom rod and the third bottom rod through a third mounting shaft 74; and the third mounting portion 7 further includes a second stopping member 75 fixedly connected in the third mounting groove 73, the second stopping member 75 includes second stopping plates 751 respectively arranged at inner sides of the two third mounting side plates 71 and a second stopping portion 752 connected between lower portions of the two second stopping plates 751, the second stopping portion 752 is arranged at one end of the third mounting side plate 71 close to the first connecting member 44, the third mounting shaft 74 is arranged at one end of the third mounting side plate 71 away from the first connecting member 44, the second stopping portion 752 is provided with a fifth limiting surface 753 arranged at the top and a sixth limiting surface 754 close to one side of the first mounting shaft 55, outer sides of the second bottom rod and the third bottom rod are provided with a fifth abutting surface 755 and sixth abutting surfaces 756 arranged at intervals on one side of the fifth abutting surface 755 away from the first connecting member 44, when the support frame is driven to be unfolded, the fifth abutting surface 755 can abut against the fifth limiting surface 753 for limiting, when the cart frame body is driven to be folded, the sixth abutting surface 756 can abut against the sixth limiting surface 754 for limiting, so that the two ends of the bottom rod can be kept parallel to each other, and the loading stability is improved, and the second stopping portion 752 and the two second stopping plates 751 surround to form a groove matched with the second bottom rods arranged correspondingly and the third bottom rods arranged correspondingly, so that the positions of the bottom rods do not deviate, folding and unfolding are easier, the bottom rods are more fitted together after being folded, and the size after being folded is reduced.

As shown in FIG. 2, the second mounting member 421 of the first underframe assembly 41 is integrally formed with the second mounting member 421 of the second underframe assembly 42 to form a second mounting structure, and the second mounting base portion 6 of the second mounting member 421 of the first underframe assembly 41 and the second mounting base portion 6 of the second mounting member 421 of the second underframe assembly 42 are of a same structure; and the third mounting member 431 of the first underframe assembly 41 is integrally formed with the third mounting member 431 of the second underframe assembly 42 to form a third mounting structure, and the second mounting base portion 6 of the third mounting member 431 of the first underframe assembly 41 and the second mounting base portion 6 of the third mounting member 431 of the second underframe assembly 42 are of a same structure. According to the multi-underframe structure, the area of a support surface is increased, and the loading capacity is improved, the support space is increased, and the whole cart structure is not prone to deformation when being loaded with a small-size heavy weight object.

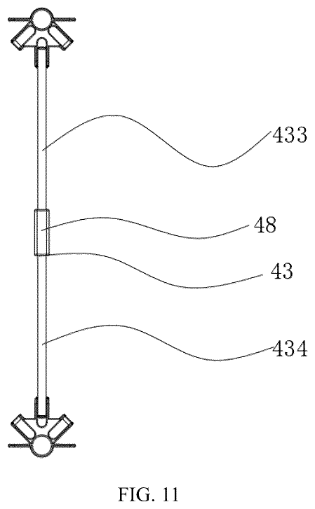

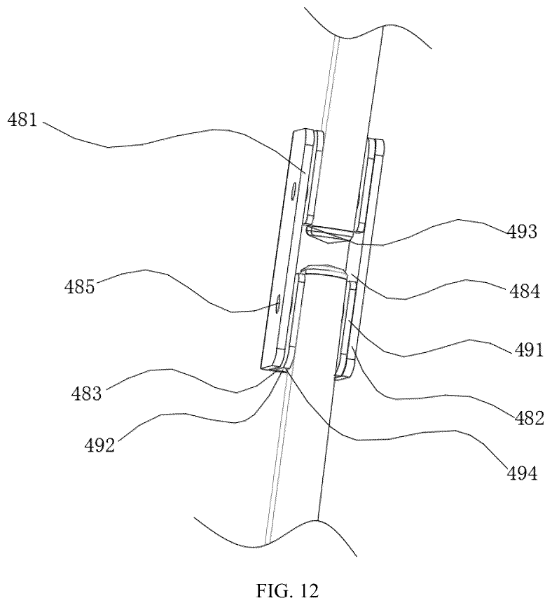

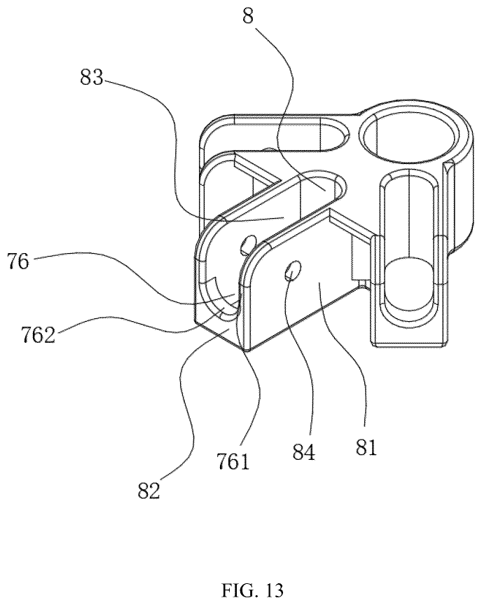

As shown in FIG. 11 to FIG. 13, the underframe structure 4 further includes a third underframe assembly 43 arranged between the first underframe assembly 41 and the second underframe assembly 42, the third underframe assembly 43 includes a fourth bottom rod 433, a fifth bottom rod 434, and a second connecting member 48, the second connecting member 48 is provided with two second connecting portions 481 arranged in a same straight line direction, each second connecting portion 481 includes two second connecting side plates 482 arranged opposite to each other in a longitudinal direction and a second connecting top plate 483 connected between upper portions of the two second connecting side plates 482, the two second connecting side plates 482 and the second connecting top plate 483 surround to form a second connecting groove 484 used for arranging end portions of the fourth bottom rod and the fifth bottom rod, and the second connecting side plates 482 are rotatably connected to the fourth bottom rod and the fifth bottom rod through a second connecting shaft 485. The second connecting member 48 further includes a second limiting member, the second limiting member includes second limiting plates 491 respectively arranged at inner sides of the two second connecting side plates 482 and a second limiting portion 492 connected between the two second limiting plates 491, the second limiting portion 492 is arranged at one end of the second connecting side plate 482 close to the support stand column, and the second connecting shaft 485 is arranged at one end of the second connecting side plate 482 away from the support stand column, the second limiting portion 492 is provided with a third limiting surface 493 arranged at the bottom and a fourth limiting surface 494 close to one side of the second connecting shaft 485, so that the fourth and fifth bottom rods and the second connecting portion are located on the same plane, and the loading is more stable. The second mounting structure and the third mounting structure each include a fourth mounting portion 8 connected to a side portion of the second mounting base portion 6 and a side portion of the third mounting portion 7, the fourth mounting portion 8 is arranged between the two third mounting portions 7, and the fourth mounting portion 8 on the second mounting structure and the fourth mounting portion 8 on the third mounting structure are arranged in a same straight line direction, the fourth mounting portion 8 includes two fourth mounting side plates 81 arranged opposite to each other in a longitudinal direction and a fourth mounting bottom plate 82 connected between lower portions of the two fourth mounting side plates 81, and the two fourth mounting side plates 81 and the fourth mounting bottom plate 82 surround to form a fourth mounting groove 83 used for arranging other end portions of the fourth bottom rod and the fifth bottom rod. The fourth mounting portion 8 further includes a third stopping member 76 fixedly connected in the fourth mounting groove 83, the third stopping member 76 includes third stopping plates 761 respectively arranged at inner sides of the two fourth mounting side plates 81 and a third stopping portion 762 connected between lower portions of the two third stopping plates 761, the third stopping portion 762 is arranged at one end of the fourth mounting side plate 81 close to the second connecting member 48, and a fourth mounting shaft 84 is arranged at one end of the fourth mounting side plate 81 away from the second connecting member 48 and the fourth mounting side plates 81 are rotatably connected to the fourth bottom rod and the fifth bottom rod through the fourth mounting shaft 84, so that a support gap between the first underframe structure and the second underframe structure is filled, the support area is increased, the loading capacity is increased after being sleeved with a cloth cover, and the whole cart is not prone to deformation. When the cart frame body is driven to be folded, the fourth bottom rod 433 and the fifth bottom rod 434 are gathered with each other to drive the second connecting member 48 to move upwards.

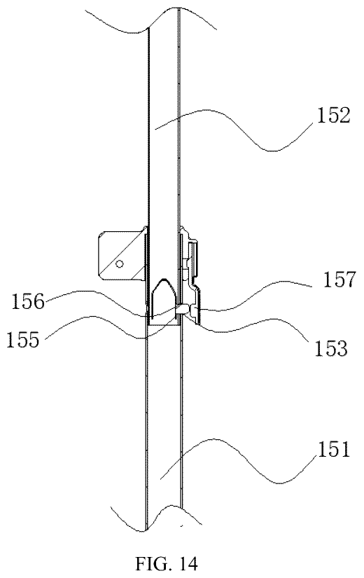

As shown in FIG. 14 and FIG. 15, the first support stand column 15 includes a first support lower column 151 and a first support upper column 152 that is telescopically sleeved in the first support lower column 151, the first support lower column 151 and the first support upper column are telescopically positioned through a first positioning assembly 153, a third connecting structure 35 is fixedly connected to an upper portion of the first support lower column 151, and a fourth connecting structure 36 is slidably connected to a lower portion of the first support lower column, upper portions of two ends of the front, rear, left, and right shear fork groups are rotatably connected to the third connecting structures 35 arranged correspondingly, respectively, and lower portions of two ends of the front, rear, left, and right shear fork groups are rotatably connected to the fourth connecting structures 36 arranged correspondingly, respectively. When the first support upper column 152 is in an unfolded state, the loading space of the whole cart can be greatly increased. The first positioning assembly 153 includes a first elastic member 155 connected to the first support upper column 152, a first positioning channel 156 formed in the first support lower column 151 and used for the first elastic member 155 to partially protrude out of the first support lower column 151, and a pressing member 157 integrally disposed with an outer side of the third connecting structure 35 or detachably connected to an outer side of the third connecting structure 35 and used for pushing the first elastic member 155 to contract into the first support lower column 151. One end of the pressing member 157 is connected to the first elastic member 155, and extends out of the first support lower column 151 through the first positioning channel 156. The first elastic member 155 is pressed by external force to contract, the pressing member 157 is retracted into the first support lower column 151. The first support upper column 152 slides into the first support lower column, and when the first support upper column is in a folded state, the upper column is retracted into the lower column, so that the length of the stand column after being folded is reduced, and the floor area is reduced; and
the pull handle assembly 3 includes a pull handle lower rod 311 and a pull handle upper rod 312 that is telescopically sleeved in the pull handle lower rod 311, the pull handle lower rod 311 and the pull handle upper rod 312 are telescopically positioned through a second positioning assembly 313, a handle member is connected to an upper end of the pull handle upper rod 312, and the second positioning assembly 313 includes a second elastic member 314 connected to the pull handle upper rod 312, and a second positioning channel 315 formed in the pull handle lower rod 311 and used for the second elastic member 314 to partially protrude out of the pull handle lower rod 311. Through telescopic adjustment, the most suitable position of the pull handle can be adjusted according to the heights of different users when the cart is used.

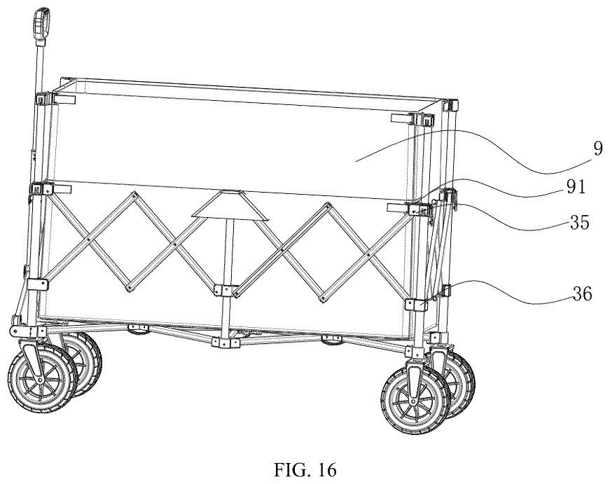

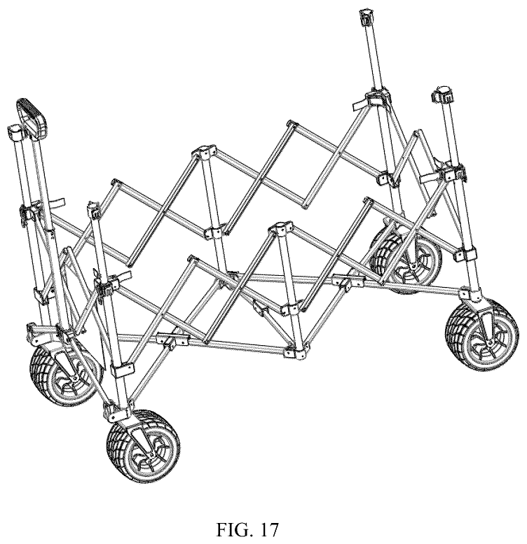

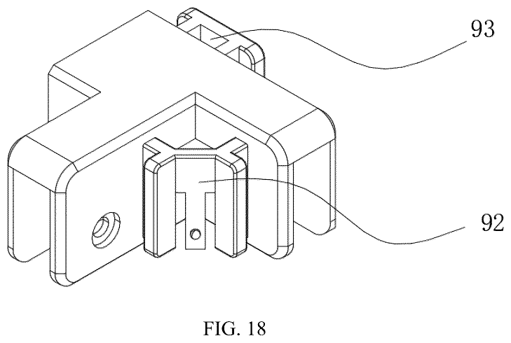

As shown in FIG. 16 to FIG. 18, as a second embodiment of the present invention, a folding cart is further provided. The folding cart includes a support frame and a cloth cover structure 9 mounted in the cart frame body, a third connecting structure 35 is fixedly connected to an upper portion of the first support stand column 15, and a fourth connecting structure 36 is slidably connected to a lower portion of the first support stand column, upper portions of two ends of the front, rear, left, and right shear fork groups are rotatably connected to the third connecting structures 35 arranged correspondingly, respectively, and lower portions of two ends of the front, rear, left, and right shear fork groups are rotatably connected to the fourth connecting structures 36 arranged correspondingly, respectively; and
a first mounting buckle 91 arranged corresponding to the third connecting structure 35 is arranged on the cloth cover structure 9, a first quick-release buckle 92 detachably connected to the first mounting buckle 91 is arranged on an inner side of the third connecting structure 35, so that it is convenient to mount or dismount a cloth cover, and an outer side of the third connecting structure 35 is provided with a second quick-release buckle 93 used for connection accessories such as a table board and a ceiling, so that it is convenient to mount or dismount the connection accessories such as the table board and the ceiling.

Finally, it should be noted that the above embodiments are only used to illustrate the technical solutions of the present invention rather than limiting thereto. Although the present invention has been described in detail with reference to the foregoing embodiments, those of ordinary skill in the art should understand that the technical solutions recited in the foregoing embodiments may still be modified, or some of the technical features thereof may be replaced with equivalents. These modifications or replacements do not make the essence of the corresponding technical solution deviate from the scope of the technical solutions in the embodiments of the present invention.

In conclusion, the foregoing descriptions are merely preferred embodiments of the present invention, and all equivalent changes and modifications made in accordance with the patent application scope of the present invention shall fall within the scope covered by the present invention.

What is claimed is:

1. A bundle-shaped folded support frame, comprising a cart frame body, a wheel body assembly used for driving the cart frame body to move, and a pull handle assembly used for pushing and pulling the cart frame body, wherein
the cart frame body comprises a front shear fork group, a rear shear fork group, a left shear fork group and a right shear fork group, and further comprises a first support stand column rotatably connected to end portions of the two adjacent shear fork groups, a second support stand column rotatably connected to the left shear fork group, a third support stand column rotatably connected to the right shear fork group, and an underframe structure connected among lower portions of each first support stand column, second support stand column and third support stand column;
the second support stand column and the third support stand column are arranged opposite to each other, the underframe structure comprises a first underframe assembly disposed between the lower portion of the first support stand column at two ends of the front shear fork group and the second support stand column and the third support stand column arranged opposite to each other, and a second underframe assembly disposed between the lower portion of the first support stand column at two ends of the rear shear fork group and the second support stand column and the third support stand column arranged opposite to each other; and
the first underframe assembly and the second underframe assembly are respectively provided with a first mounting member connected to the lower portion of each first support stand column, a second mounting member connected to the lower portion of the second support stand column, a third mounting member connected to the lower portion of the third support stand column, and a first connecting member, a first bottom rod of which two ends are rotatably connected to a lower side of the first connecting member and an upper side of the first mounting member respectively, a second bottom rod of which two ends are rotatably connected to the lower side of the first connecting member and an upper side of the second mounting member respectively, and a third bottom rod of which two ends are rotatably connected to the lower side of the first connecting member and an upper side of the third mounting member respectively, and when the cart frame body is driven to be folded, the front, rear, left and right shear fork groups deform to drive the first support stand columns, the second support stand columns and the third support stand columns to gather with each other, and the first bottom rod, the second bottom rod and the third bottom rod are gathered with each other to drive the first connecting member to move upwards.

2. The support frame according to claim 1, wherein the first connecting member is provided with four first connecting portions used for connecting the two first bottom rods, the second bottom rod, and the third bottom rod respectively, each first connecting portion comprises two first connecting side plates arranged opposite to each other in a longitudinal direction and a first connecting top plate connected between upper portions of the two first connecting side plates, the two first connecting side plates and the first connecting top plate surround to form a first connecting groove used for arranging an end portion of the bottom rod, and the first connecting side plates are rotatably connected to the bottom rod through a first connecting shaft.

3. The support frame according to claim 2, wherein the first connecting portion further comprises a first limiting member fixedly connected to an inner side of the first connecting groove, the first limiting member comprises first limiting plates respectively arranged at inner sides of the two first connecting side plates and a first limiting portion connected between upper portions of the two first limiting plates, the first limiting portion is arranged at one end of the first connecting side plate close to the support stand column, the first connecting shaft is arranged at one end of the first connecting side plate away from the support stand column, the first limiting portion is provided with a first limiting surface arranged at the bottom and a second limiting surface close to one side of the first connecting shaft, an outer side of the bottom rod is provided with a first abutting surface and second abutting surfaces arranged at intervals on one side of the first abutting surface away from the support stand column, when the support frame is driven to be unfolded, the first abutting surface can abut against the first limiting surface for limiting, and when the cart frame body is driven to be folded, the second abutting surface can abut against the second limiting surface for limiting.

4. The support frame according to claim 2 wherein the first connecting member comprises a first connecting strip and a second connecting strip arranged perpendicular to each other in a crossed manner, a lower opening portion is arranged in the middle of the first connecting strip, an upper opening portion is arranged in the middle of the second connecting strip, the lower opening connecting portion is matched with the upper opening connecting portion in a buckled manner, after matching, a top surface of the first connecting strip and a top surface of the second connecting strip are located on the same plane and a bearing support surface used for abutting against the bottom of a cloth cover structure is formed, and the first connecting portions are formed at two ends of the first connecting strip and the second connecting strip respectively.

5. The support frame according to claim 4, wherein the first mounting member comprises a first mounting base portion that is sleeved with the lower portion of the first support stand column and is relatively fixed, and a first mounting portion connected to one side of the first mounting base portion, the first mounting portion comprises two first mounting side plates arranged opposite to each other in a longitudinal direction and a first mounting bottom plate connected between lower portions of the two first mounting side plates, the two first mounting side plates and the first mounting bottom plate surround to form a first mounting groove used for arranging an end portion of the first bottom rod, and the first mounting side plates are rotatably connected to the first bottom rod through a first mounting shaft; the first mounting portion further comprises a first stopping member fixedly connected in the first mounting groove, the first stopping member comprises first stopping plates respectively arranged at inner sides of the two first mounting side plates and a first stopping portion connected between lower portions of the two first stopping plates, the first stopping portion is arranged at one end of the first mounting side plate close to the first connecting member, the first mounting shaft is arranged at one end of the first mounting side plate away from the first connecting member, the first stopping portion is provided with a first stopping surface arranged at the top and a second stopping surface close to one side of the first mounting shaft, an outer side of the first bottom rod is provided with a third abutting surface and fourth abutting surfaces arranged at intervals on one side of the third abutting surface away from the first connecting member, when the support frame is driven to be unfolded, the third abutting surface can abut against the first stopping surface for limiting, and when the cart frame body is driven to be folded, the fourth abutting surface can abut against the second stopping surface for limiting, the first stopping portion and the two first stopping plates surround to form a groove matched with the first bottom rods arranged correspondingly, and the first limiting portion and the two limiting plates surround to form a groove matched with the bottom rods arranged correspondingly; or
the first mounting member comprises a first mounting base portion that is sleeved with the lower portion of the first support stand column and is relatively fixed, a first mounting portion connected to one side of the first mounting base portion, and a second mounting portion connected to the other side of the first mounting base portion, the first mounting portion is rotatably connected to the first bottom rod, the second mounting portion comprises two second mounting side plates arranged opposite to each other in a longitudinal direction and a second mounting groove formed by the two second mounting side plates in a surrounding manner, the pull handle assembly comprises a pull handle rod, two connecting rods respectively arranged at two sides of the pull handle rod, a first connecting structure connected between a lower portion of the pull handle rod and upper ends of the two connecting rods, and a second connecting structure respectively connected between lower ends of the two connecting rods and the two first mounting portions, two ends of each connecting rod are rotatably connected to the first connecting structure and the second connecting structure through a rotating shaft arranged transversely, a lower portion of the second connecting structure is located in the second mounting groove and is rotatably connected to the second mounting side plates through a second mounting shaft, the rotating shaft is arranged along a length direction of the cart frame body, and the second mounting shaft is arranged along a width direction of the cart frame body.

6. The support frame according to claim 1, wherein the second mounting member and the third mounting member respectively comprises a second mounting base portion that is sleeved with the lower portions of the second support stand column and the third support stand column and is relatively fixed, and a third mounting portion connected to a side portion of the second mounting base portion, the third mounting portion comprises two third mounting side plates arranged opposite to each other in a longitudinal direction and a third mounting bottom plate connected between lower portions of the two third mounting side plates, the two third mounting side plates and third mounting bottom plate surround to form a third mounting groove used for arranging end portions of the second bottom rod and the third bottom rod, and the third mounting side plates are rotatably connected to the second bottom rod and the third bottom rod through a third mounting shaft; and
the third mounting portion further comprises a second stopping member fixedly connected in the third mounting groove, the second stopping member comprises second stopping plates respectively arranged at inner sides of the two third mounting side plates and a second stopping portion connected between lower portions of the two second stopping plates, the second stopping portion is arranged at one end of the third mounting side plate close to the first connecting member, the third mounting shaft is arranged at one end of the third mounting side plate away from the first connecting member, the second stopping portion is provided with a fifth limiting surface arranged at the top and a sixth limiting surface close to one side of the first mounting shaft, outer sides of the second bottom rod and the third bottom rod are provided with a fifth abutting surface and sixth abutting surfaces arranged at intervals on one side of the fifth abutting surface away from the first connecting member, when the support frame is driven to be unfolded, the fifth abutting surface can abut against the fifth limiting surface for limiting, when the cart frame body is driven to be folded, the sixth abutting surface can abut against the sixth limiting surface for limiting, and the second stopping portion and the two second stopping plates surround to form a groove matched with the second bottom rods arranged correspondingly and the third bottom rods arranged correspondingly.

7. The support frame according to 6, wherein the second mounting member of the first underframe assembly is integrally formed with the second mounting member of the second underframe assembly to form a second mounting structure, and the second mounting base portion of the second mounting member of the first underframe assembly and the second mounting base portion of the second mounting member of the second underframe assembly are of a same structure; and
the third mounting member of the first underframe assembly is integrally formed with the third mounting member of the second underframe assembly to form a third mounting structure, and the second mounting base portion of the third mounting member of the first underframe assembly and the second mounting base portion of the third mounting member of the second underframe assembly are of a same structure.

8. The support frame according to claim 7, wherein the underframe structure further comprises a third underframe assembly arranged between the first underframe assembly and the second underframe assembly, the third underframe assembly comprises a fourth bottom rod, a fifth bottom rod, and a second connecting member, the second connecting member is provided with two second connecting portions arranged in a same straight line direction, each second connecting portion comprises two second connecting side plates arranged opposite to each other in a longitudinal direction and a second connecting top plate connected between upper portions of the two second connecting side plates, the two second connecting side plates and the second connecting top plate surround to form a second connecting groove used for arranging end portions of the fourth bottom rod and the fifth bottom rod, and the second connecting side plates are rotatably connected to the fourth bottom rod and the fifth bottom rod through a second connecting shaft;
the second mounting structure and the third mounting structure each include a fourth mounting portion connected to a side portion of the second mounting base portion and/or a side portion of the third mounting portion, the fourth mounting portion is arranged between the two third mounting portions, and the fourth mounting portion on the second mounting structure and the fourth mounting portion on the third mounting structure are arranged in a same straight line direction, the fourth mounting portion comprises two fourth mounting side plates arranged opposite to each other in a longitudinal direction and a fourth mounting bottom plate connected between lower portions of the two fourth mounting side plates, the two fourth mounting side plates and the fourth mounting bottom plate surround to form a fourth mounting groove used for arranging other end portions of the fourth bottom rod and the fifth bottom rod, and the fourth mounting side plates are rotatably connected to the fourth bottom rod and the fifth bottom rod through a fourth mounting shaft; and
when the cart frame body is driven to be folded, the fourth bottom rod and the fifth bottom rod are gathered with each other to drive the second connecting member to move upwards.

9. The support frame according to claim 1, wherein the first support stand column comprises a first support lower column and a first support upper column that is telescopically sleeved in the first support lower column, the first support lower column and the first support upper column are telescopically positioned through a first positioning assembly, a third connecting structure is fixedly connected to an upper portion of the first support lower column, and a fourth connecting structure is slidably connected to a lower portion of the first support lower column, upper portions of two ends of the front, rear, left, and right shear fork groups are rotatably connected to the third connecting structures arranged correspondingly, respectively, and lower portions of two ends of the front, rear, left, and right shear fork groups are rotatably connected to the fourth connecting structures arranged correspondingly, respectively, the first positioning assembly comprises a first elastic member connected to the first support upper column, a first positioning channel formed in the first support lower column and used for the first elastic member to partially protrude out of the first support lower column, and a pressing member integrally disposed with an outer side of the third connecting structure or detachably connected to an outer side of the third connecting structure and used for pushing the first elastic member to contract into the first support lower column; and/or,
the pull handle assembly comprises a pull handle lower rod and a pull handle upper rod that is telescopically sleeved in the pull handle lower rod, the pull handle lower rod and the pull handle upper rod are telescopically positioned through a second positioning assembly, a handle member is connected to an upper end of the pull handle upper rod, and the second positioning assembly comprises a second elastic member connected to the pull handle upper rod, and a second positioning channel formed in the pull handle lower rod and used for the second elastic member to partially protrude out of the pull handle lower rod.

10. A folding cart, comprising the support frame according to claim 1 and a cloth cover structure mounted in the cart frame body, a third connecting structure is fixedly connected to an upper portion of the first support stand column, and a fourth connecting structure is slidably connected to a lower portion of the first support stand column, upper portions of two ends of the front, rear, left, and right shear fork groups are rotatably connected to the third connecting structures arranged correspondingly, respectively, and lower portions of two ends of the front, rear, left, and right shear fork groups are rotatably connected to the fourth connecting structures arranged correspondingly, respectively; and
a first mounting buckle arranged corresponding to the third connecting structure is arranged on the cloth cover structure, a first quick-release buckle detachably connected to the first mounting buckle is arranged on an inner side of the third connecting structure, and a second quick-release buckle used for connecting an accessory is arranged on an outer side of the third connecting structure.
